(19) United States
(12) Patent Application Publication
(10) Pub. No.: US 2026/0119908 A1
(43) Pub. Date: Apr. 30, 2026

(54) TECHNIQUE FOR MANAGING A HISTORY STORAGE USED FOR PREDICTION

(71) Applicant: Arm Limited, Cambridge (GB)

(72) Inventors: Wasim Rahim SHAIKH, Tempe, AZ (US); Joseph Anthony DELGROSS, Chandler, AZ (US); Kim Richard SCHUTTENBERG, Gilbert, AZ (US); Houdhaifa BOUZGUARROU, Austin, TX (US)

(21) Appl. No.: 18/928,537

(22) Filed: Oct. 28, 2024

(51) Int. Cl. G06N 5/022

(52) U.S. Cl. CPC G06N 5/022

(57) ABSTRACT

An apparatus has history storage for maintaining history information comprising a sequence of history indicators generated during execution of a program by processing circuitry, and update circuitry, responsive to a given update event detected during execution of the program, to generate a history indicator associated with the given update event, and to update the history information using the generated history indicator. Prediction circuitry, responsive to a given prediction event detected during execution of the program, uses at least a portion of the history information to identify prediction information and generates a prediction associated with the given prediction event in dependence on the identified prediction information. The update circuitry is configured to detect whether an aliasing concern condition is present indicating that the history information may be insufficient, for at least one prediction event, to enable the prediction circuitry to discriminate between different contexts of that at least one prediction event that are dependent on execution history of the program. Absent detection of the aliasing concern condition, the update circuitry performs a default indicator generation operation to generate the history indicator associated with the given update event, but when the aliasing concern condition is detected, it instead performs a modified indicator generation operation to generate the history indicator associated with the given update event.

### BACKGROUND

The present technique relates to the field of data processing, and more particularly to techniques for managing a history storage used for prediction within a data processing apparatus.

In modern data processing systems, prediction mechanisms are often employed to seek to improve performance. When seeking to make a prediction associated with a given event occurring within a data processing apparatus, it is often the case that one or more aspects of the previous operation history of the data processing apparatus will affect the given event, and hence affect the prediction that should be made in relation to it. For instance, where the given event is a particular branch instruction encountered within a program being executed on the data processing apparatus, the outcome of that branch instruction (for example whether the branch is taken or not taken) is often affected by the previous history of execution of the program, such as the paths through the program that have taken place prior to the branch instruction under consideration.

Hence a history storage may be provided, for reference by a prediction mechanism when seeking to make predictions, that is used to maintain history information, for example indicative of certain aspects of the history of execution of a program being executed on the data processing apparatus. This history information may comprise a sequence of history indicators, where individual history indicators are generated in response to associated events detected during execution of the program.

The accuracy of the predictions made by the prediction mechanism referencing the history information will often depend on how accurately the history information can discriminate between different execution histories of the program. However, due to the finite size of such a history storage, it is typically not possible for each history indicator to capture exact details of the associated event, and instead each history indicator is typically generated based on a certain subset of state associated with the event that caused that history indicator to be generated.

### SUMMARY

In accordance with a first example arrangement, there is provided an apparatus comprising: history storage configured to maintain history information comprising a sequence of history indicators generated during execution of a program by processing circuitry; update circuitry configured, responsive to a given update event detected during execution of the program, to generate a history indicator associated with the given update event, and to update the history information using the generated history indicator; prediction circuitry configured, responsive to a given prediction event detected during execution of the program, to use at least a portion of the history information to identify prediction information and to generate a prediction associated with the given prediction event in dependence on the identified prediction information; wherein: the update circuitry is configured to detect whether an aliasing concern condition is present indicating that the history information may be insufficient, for at least one prediction event, to enable the prediction circuitry to discriminate between different contexts of that at least one prediction event that are dependent on execution history of the program; the update circuitry is configured, absent detection of the aliasing concern condition, to perform a default indicator generation operation to generate the history indicator associated with the given update event; and the update circuitry is configured, when the aliasing concern condition is detected, to perform a modified indicator generation operation to generate the history indicator associated with the given update event.

In accordance with another example arrangement, there is provided a method of managing a history storage used for prediction, comprising: maintaining within the history storage history information comprising a sequence of history indicators generated during execution of a program by processing circuitry; generating, in response to a given update event detected during execution of the program, a history indicator associated with the given update event, and updating the history information using the generated history indicator; employing prediction circuitry, in response to a given prediction event detected during execution of the program, to use at least a portion of the history information to identify prediction information, and to generate a prediction associated with the given prediction event in dependence on the identified prediction information; detecting whether an aliasing concern condition is present indicating that the history information may be insufficient, for at least one prediction event, to enable the prediction circuitry to discriminate between different contexts of that at least one prediction event that are dependent on execution history of the program; when generating the history indicator in response to the given update event, in the absence of the aliasing concern condition being detected, performing a default indicator generation operation to generate the history indicator; and when generating the history indicator in response to the given update event, in the presence of the aliasing concern condition being detected, performing a modified indicator generation operation to generate the history indicator.

In accordance with a still further example arrangement, there is provided a system comprising: an apparatus in accordance with the first example arrangement discussed above, implemented in at least one packaged chip; at least one system component; and a board, wherein the at least one packaged chip and the at least one system component are assembled on the board. In an additional example arrangement, the above-mentioned system may be assembled on a further board with at least one other product component.

In a yet further example arrangement, there is provided a computer-readable medium storing computer-readable code for fabrication of an apparatus in accordance with the first example arrangement discussed above. The computer-readable medium may be a transitory computer-readable medium (such as wired or wireless transmission of code over a network) or a non-transitory computer-readable medium such as semiconductor, magnetic disk, or optical disc.

### BRIEF DESCRIPTION OF THE DRAWINGS

Further aspects, features and advantages of the present technique will be apparent from the following description of examples, which is to be read in conjunction with the accompanying drawings, in which:

FIG. 1 is a block diagram schematically illustrating a data processing system in which the techniques described herein may be employed, in accordance with one example implementation;

FIG. 2 illustrates branch target prediction circuitry that may be used to predict a target address for a branch instruction in accordance with one example implementation;

FIG. 3 illustrates an example of history information that may be used in one example implementation;

FIG. 4 illustrates branch direction prediction circuitry that may be used to predict whether a branch instruction will be taken or not taken, in accordance with one example implementation;

FIGS. 5A and 5B are used to schematically illustrate one scenario that may give rise to detection of an aliasing concern condition, in accordance with one example implementation;

FIG. 6 is a block diagram schematically illustrating how update circuitry may be used to update the history indicators within a history storage in accordance with one example implementation;

FIG. 7 is a flow diagram illustrating steps taken in accordance with one example implementation upon detection of an update event, in dependence on whether an aliasing concern condition is detected or not;

FIG. 8 is a flow diagram illustrating in more detail the steps taken upon detection of an update event in accordance with one particular example implementation;

FIG. 9 schematically illustrates how the aliasing concern condition scenario illustrated in FIG. 5B may be detected through the use of an extended hash, in accordance with one example implementation;

FIG. 10 is a flow diagram illustrating how an extended hash can be used to detect the aliasing concern condition, and thereby affect the history indicator added to the history information, in accordance with one example implementation;

FIG. 11 schematically illustrates another form of aliasing concern condition that may be detected, and how the path history contents may be altered upon detection of such an aliasing concern condition, in accordance with one example implementation;

FIG. 12 illustrates a particular example of the approach schematically illustrated in FIG. 11;

FIG. 13 is a flow diagram illustrating a counter mechanism that may be used to detect the presence of the aliasing concern condition, in accordance with one example implementation;

FIG. 14 is a flow diagram illustrating an alternative counter mechanism that may be used to detect the presence of the aliasing concern condition, in accordance with one example implementation;

FIG. 15 is a flow diagram schematically illustrating how an algorithm used to generate additional marker bits added to the history information in the presence of the aliasing concern condition may be altered dependent on one or more defined factors, in accordance with one example implementation; and

FIG. 16 illustrates a system and a chip-containing product.

### DESCRIPTION OF EXAMPLES

In one example implementation, an apparatus is provided that has history storage configured to maintain history information comprising a sequence of history indicators generated during execution of a program by processing circuitry. Responsive to a given update event detected during execution of the program, update circuitry is then configured to generate a history indicator associated with the given update event, and to update the history information using the generated history indicator. There are various ways in which the history information may be updated using the generated history indicator. However, in one example implementation, the history storage has a finite size and once the history storage is full, each newly generated history indicator added to the history storage displaces a corresponding number of bits of the oldest history information within the history storage.

The apparatus further has prediction circuitry that is configured, responsive to a given prediction event detected during execution of the program, to use at least a portion of the history information to identify prediction information and to generate a prediction associated with the given prediction event in dependence on the identified prediction information. There are various ways in which the history information can be used to identify prediction information. However, in one example implementation the history information, or a portion thereof, is used to identify one or more entries within a prediction storage, with those one or more entries comprising the prediction information upon which the prediction is then based.

In accordance with the techniques described herein, the update circuitry is configured to detect whether an aliasing concern condition is present indicating that the history information may be insufficient, for at least one prediction event, to enable the prediction circuitry to discriminate between different contexts of that at least one prediction event that are dependent on execution history of the program. Further, the form of the history indicator generated in response to the given update event is dependent upon whether the aliasing concern condition is considered to be present or not. In particular, the update circuitry is configured, absent detection of the aliasing concern condition, to perform a default indicator generation operation to generate the history indicator associated with the given update event. However, when the aliasing concern condition is detected, the update circuitry is instead configured to perform a modified indicator generation operation to generate the history indicator associated with the given update event.

Hence, in accordance with the techniques described herein, the update circuitry is arranged to seek to detect whether an aliasing concern condition is present or not, and in the event that condition is determined to be present the update circuitry is arranged to generate an alternative history indicator to be used to update the history information than the history indicator that would have been used were the aliasing concern condition not determined to be present. It has been found that such an approach can reduce the likelihood of the prediction circuitry being unable to discriminate between different contexts of certain prediction events, and hence can improve prediction accuracy.

There are various ways in which the aliasing concern condition may be detected by the update circuitry. However, in one example implementation the update circuitry is configured to perform the default indicator generation operation in order to generate a candidate history indicator, and in the event that updating the history information using the candidate history indicator would give rise to the aliasing concern condition, to instead update the history information using the history indicator generated by performing the modified indicator generation operation. Thus, in accordance with such an implementation, a check to detect the presence or absence of the aliasing concern condition is made once the candidate (default) history indicator has been generated using the default indicator generation operation. Such an approach enables the update circuitry to detect when use of the default history indicator to update the history information would give rise to the aliasing concern condition, and then to seek to prevent that aliasing concern condition by instead using the modified indicator generation operation to generate an alternative history indicator to be used to update the history information.

In one example implementation, the update circuitry is configured to employ the default indicator generation operation to generate the history indicator (also referred to herein as the default history indicator) based on at least one item of state associated with the given update event. The item or items of state used may vary dependent on implementation. However, purely by way of illustrative example, the prediction circuitry may be used to predict the outcome of a branch instruction (for example whether the branch is predicted to be taken or not taken), and each update event may relate to a preceding branch instruction that is taken (this may be predicted to be taken or actually in due course taken, and indeed as will be discussed in more detail later both predicted history information (based on speculative execution of branch instructions) and actual history information (based on committed branch instructions) may be maintained). In such an example implementation, the one or more items of state used may comprise at least one or more bits of the target address of such a branch instruction.

Irrespective of what item or items of state are used as an input, in one example implementation the algorithm employed by the default indicator generation operation to generate the default history indicator is such that the value of the default history indicator generated is entirely deterministic and reproducible given the input item or items of state associated with the given update event.

Whilst in one example implementation the history indicator (also referred to herein as the modified history indicator) generated by the modified indicator generation operation could be generated entirely independently of the default history indicator generated by the default indicator generation operation, provided the generation of the modified history indicator is reliably reproducible for any given update event, in one example implementation the update circuitry is configured, when the aliasing concern condition is detected, to perform the modified indicator generation operation in order to apply a reproducible modification to the default history indicator in order to generate the modified history indicator to be used as the history indicator associated with the given update event. Hence, in accordance with such an implementation, the default history indicator is used as a starting point by the modified indicator generation operation when producing the modified history indicator. Since the default history indicator is entirely deterministic and reproducible given the input item or items of state associated with the given update event, and the modified indicator generation operation applies a reproducible modification to the default history indicator, then such an approach ensures that the modified history indicator is also entirely deterministic and reproducible for any given input item or items of state.

There are various ways in which the modified history indicator may be generated based on the default history indicator. For example, the reproducible modification applied by the modified indicator generation operation may comprise applying a predetermined arithmetic operation to the default history indicator in order to generate as the modified history indicator a replacement history indicator used instead of the default history indicator. Since a predetermined arithmetic operation is applied to the default history indicator it will be appreciated that the replacement history indicator generated will be entirely repeatable for any given default history indicator. In one example implementation, the replacement history indicator may have the same number of bits as the default history indicator, and hence will occupy the same amount of space within the history storage as the default history indicator would have occupied. However, in an alternative implementation the number of bits forming the replacement history indicator may differ to the number of bits forming the default history indicator if desired.

As an alternative to applying the above-mentioned predetermined arithmetic operation to the default history indicator in order to generate a replacement history indicator, the reproducible modification applied by the modified indicator generation operation may instead involve generating in a repeatable manner one or more additional indicator bits that are used, in combination with the default history indicator, as the modified history indicator. Hence, in this case the modified history indicator is larger than the default history indicator, and includes within it the default history indicator.

The way in which the one or more additional indicator bits are generated may vary dependent on implementation. In one example implementation, the update circuitry is configured to derive the one or more additional indicator bits by performing a predetermined computation using as input one or more bits of the default history indicator. Hence, the value of the one or more additional indicator bits will be dependent on the value of the default history indicator. In an alternative implementation, the one or more additional indicator bits may not be generated in dependence on the default history indicator, but instead any other suitable mechanism could be used to generate the additional indicator bits, provided the mechanism is reliably reproducible. For example, the one or more additional indicator bits may be set in dependence on one or more further items of state associated with the given update event, such as additional items of state whose values are considered to be dependent on the context associated with the given update event and hence are likely to vary dependent on execution history of the program.

There are various checks that the update circuitry may make in order to seek to detect the presence or absence of the aliasing concern condition. In one example implementation, the update circuitry is configured to detect the aliasing concern condition when the history indicator generated by the default indicator generation operation for the given update event has a same value as the history indicator used to update the history information that was associated with a preceding update event, when that preceding update event is other than a previous iteration of the given update event. Hence, when the update circuitry detects that the value of the history indicator generated for the given update event matches the value of the history indicator that was used to update the history information for a preceding update event, and it is determined that that preceding update event is a different underlying event than the given update event (rather than just being a previous occurrence of the given update event), then this may cause the update circuitry to determine that the aliasing concern condition has been detected.

Whilst the preceding update event that is chosen for the purposes of the above evaluation may be varied dependent on implementation, in one example implementation the preceding update event considered by the update circuitry is a last update event prior to the given update event. However, in an alternative implementation the above check could be made in respect of multiple previous events, to detect whether any one of those previous events used the same value of history indicator as has been generated for the current given update event, and related to a different underlying event than the given update event, and in that case to trigger detection of the aliasing concern condition. Considering by way of illustration a situation where the update events relate to occurrences of taken branch instructions, such an approach could for example be used to not just de-alias sequential, but different, branch instructions for which the same history indicator is generated, but any different branch instructions appearing within a certain window of execution for which the same history indicator value is generated. However it has been found that in many practical situations most of the benefit can be realised by just considering the immediately preceding branch instruction.

In implementations that use the above-mentioned approach to detect the aliasing concern condition, there are a variety of mechanisms that could be used to both detect that the history indicator value generated for the current given update event is the same as the history indicator value generated for a preceding update event, and that the underlying update events are different. However, in one example implementation this is achieved through the use of extended history indicators. In particular, the update circuitry may be configured to generate each history indicator used to update the history information such that that history indicator comprises P bits, but is also configured, when performing the default indicator generation operation, to perform an extended indicator generation operation to generate an extended history indicator comprising R bits, where R is great than P. Further, the update circuitry may be configured to maintain the history indicator and the extended history indicator generated for the preceding update event, and to detect the aliasing condition when the history indicator generated by the default indicator generation operation for the given update event has a same value as the history indicator generated for the preceding update event, but the extended history indicator generated by the extended indicator generation operation for the given update event has a different value to that of the extended history indicator generated by the extended indicator generation operation for the preceding update event.

By generating an extended history indicator comprising more bits than the standard history indicator, this increases the likelihood that the extended history indicators will differ for two different update events even if the standard history indicators do not. Hence, the presence of differing extended history indicator values in the presence of identical standard history indicator values may be used to infer that the underlying update events are different (as opposed to just relating to two iterations of the same update event). This can hence provide a simple and effective mechanism for detecting the aliasing concern condition.

In some example implementations, both the default indicator generation operation and the extended indicator generation operation may receive the same inputs, for example the same items of state associated with the relevant update event. However, if desired, the extended indicator generation operation may receive more input state than is used by the default indicator generation operation, which can further assist in detecting aliasing of the standard history indicators for two different update events by increasing the likelihood that the extended history indicators will differ even if the standard history indicators do not.

It should be noted that it will typically not be practical to use the extended history indicators themselves to update the history storage so as to avoid the above-mentioned aliasing issue, since the history storage will be of a finite size and use of the extended history indicators within the history storage would ultimately reduce the amount of history that could be maintained within the history storage, when compared with use of the standard history indicators. However, the above approach allows such extended history indicators to be used to detect the above-mentioned aliasing issue, and upon such detection the earlier-mentioned modified indicator generation operation can be used to generate a modified history indicator to be used to update the history information instead of the default history indicator, thereby avoiding using two identical history indicator values within the history storage for both the current given update event and a preceding, different, update event.

It should be noted that in alternative implementations different mechanisms may be used to detect the aliasing concern condition. For instance, in one example implementation the update circuitry may be configured to detect the aliasing concern condition when a stagnancy threshold is detected in respect of the history information maintained in the history storage. Dependent on implementation, this stagnancy threshold may be detected in respect of the entirety of the history information, or in respect of some subset of that history information, for example half of the history information, a quarter of the history information, etc.

When such stagnancy in the contents of the history information is detected, this is indicative of a potential aliasing issue, since it then becomes likely that the prediction circuitry, when seeking to use that history information to identify prediction information, will be unable to discriminate between different contexts of at least one prediction event that are dependent on execution history of the program. For instance, when considering by way of example branch direction prediction made in respect of branch instructions, in situations where the history information becomes stagnant, the prediction circuitry is unlikely to be able to use the history information to distinguish between an iteration of a given branch instruction that should be predicted as taken and a different iteration of the given branch instruction that should be predicted as not taken. However, if the aliasing concern condition is detected based on observation that a stagnancy threshold has been reached, then the use of the above described techniques can be used to inject a modified history indicator into the history storage, and thereby inject a perturbation into the history information contents that increases entropy in the history information, and hence increases the likelihood of being able to distinguish between different contexts of the same branch instruction.

There are various ways in which the stagnancy threshold may be detected. In one example implementation, the update circuitry is configured to detect the stagnancy threshold when at least a portion of at least one version of the history information prior to update in response to the given update event matches a corresponding portion of updated history information that would arise were a current version of the history information updated using the history indicator generated for the given update event by the default indicator generation operation. Hence, such a check can be used to determine when addition of the default history indicator for the given update event will not change the content of the history information, and hence does not add any useful information. In such cases, a modified history indicator can be generated in order to ensure that a change in the overall content of the history information does occur when the history information is updated.

In one example implementation, the entirety of the history information that would be present following an update based on the default history indicator for the given update event is compared with the entirety of a previous version of the history information in order to detect the stagnancy threshold, but, as per the earlier comment, if desired the above check could be performed based on a particular portion of the history information, for example a particular half of the history information or a particular quarter of the history information. Such an approach may reduce the start-up cost associated with observing the effect of adding a modified history indicator, but is likely to result in the insertion of more modified history indicators.

In one example implementation, the above comparison is performed in respect of just one version of the history information, namely the version of the history information immediately prior to any update in response to the given update event. However, if desired, the comparison could be repeated in respect of multiple preceding versions of the history information before triggering use of the modified history indicator. Hence, by way of example, the use of such a modified history indicator may in such an implementation only occur if stagnancy is detected as a result of comparisons with two or more preceding versions of the history information.

It should be noted that the above approach of comparing the history information pre-update with the history information that would occur post-update using the default history indicator is not the only mechanism that could be used to detect the stagnancy threshold. For example, in an alternative implementation the update circuitry may comprise counter circuitry used to track a number of consecutive updates to the history information that use a same value of the history indicator, and to detect the stagnancy threshold when that number reaches a threshold value. Purely by way of example, considering a situation where stagnancy is detected in respect of the entirety of the contents of the history storage, if the history storage is able to store N×P bits, where P is the number of bits provided by a default history indicator, then if such a counter mechanism detects that N updates have occurred using the same value of history indicator this will indicate that the history information is stagnant. This can hence be used to trigger detection of the aliasing concern condition, and thereby cause a modified history indicator to be inserted into the history storage to seek to disrupt the stagnancy.

The counter circuitry can take a variety of forms. For example, a single counter could be maintained which is reset each time a generated history indicator differs from the last one used to update the history storage, and which is incremented each time a generated history indicator matches the last one used to update the history storage. This would require maintaining a copy of the previously used history indicator for comparison purposes. Alternatively, if it was desired to avoid such a comparison being needed, separate counters could be kept for each possible value of the history indicator, such that each generated history indicator causes the corresponding counter value to be incremented, and all the other counter values to be reset. If any counter value reaches a threshold level, this will indicate that the stagnancy threshold has been reached.

In implementations where the modified indicator generation operation is used to apply a reproducible modification to the default history indicator by generating in a repeatable manner one or more additional indicator bits that are used, in combination with the default history indicator, as the modified history indicator, then in one example implementation the algorithm used to generate the one or more additional bits may be fixed. However, in an alternative implementation, the update circuitry may be configured to alter the algorithm used in a reproducible manner in dependence on one or more defined factors. This can provide further flexibility in the form of the modified history indicator that is added, and in particular may enable different mechanisms to be tried to seek to avoid future occurrences of the aliasing concern condition. For example, if a particular algorithm has been used to insert a modified history indicator, but in due course the aliasing concern condition has re-arisen, use of an alternative algorithm to generate a different form of modified history indicator may help in preventing further occurrences of the aliasing concern condition.

The one or more defined factors that may be considered when determining the form of algorithm to be used in order to generate the one or more additional bits can take a variety of forms. For instance, the one or more defined factors may comprise an indication of an iteration count associated with a loop of instructions being executed within the program, such that the form of modified history indicator generated may vary dependent on loop iteration. Alternatively, or in addition, as noted above a previous use of a modified history indicator to update history information may be taken into account when determining a current algorithm to be used to generate a modified history indicator.

The techniques described herein may be useful in a variety of scenarios where prediction circuitry is used to make predictions based on previous execution history of a program. For instance, in addition to branch prediction mechanisms used to predict outcomes of branch instructions, prediction mechanisms may also be used to make other predictions, for example to predict data values, to predict data to be prefetched from memory into a cache, etc.

However, in one example implementation the techniques described herein are used when predicting an outcome of branch instructions, for example whether those branch instruction should be predicted as taken or not taken. In such an implementation, the history storage may be configured to maintain, as the history information, path history information indicative of paths through the program that occur when the program is executed by the processing circuitry, and the given update event may be associated with a branch instruction in the program that causes a taken path to be followed from the branch instruction. Further, the given prediction event may comprise detection of an upcoming branch instruction in the program and the prediction circuitry may be configured to generate a prediction of a branch outcome for the upcoming branch instruction. In such an implementation, the different contexts that the prediction circuitry may be unable to discriminate between based on the history information, when the aliasing concern condition is present, are different branch outcomes for at least one upcoming branch instruction. In one example implementation, as noted above, the given update event is associated with a branch instruction that causes a taken path to be followed, and hence the history storage is only updated for taken branches. In an alternative implementation, if desired, the history storage may also be updated for non-taken branches.

In one such example implementation, the apparatus may further comprise prediction storage having a plurality of prediction entries, where each prediction entry is configured to store prediction information used to generate a prediction of the branch outcome. The prediction circuitry may then be configured, responsive to the given prediction event, to use at least a portion of the history information to identify at least one prediction entry within the prediction storage, and to generate the prediction in dependence on the prediction information stored in the at least one identified prediction entry. There are various types of branch prediction mechanism that employ such an approach. For example, in a TAGE (TAgged GEometric length) prediction scheme, different portions of the history information may be used to identify entries in a series of TAGE tables, and if there is a hit in an entry for more than one table, the prediction information in the hit entry accessed using the largest amount of the history information is used when determining the prediction to be made. As another example, when using a perceptron prediction scheme, the history information is used to obtain weights from entries in a number of tables, with those various weights then being combined to form a final prediction.

In some example implementations more than one form of history information may be maintained. For example, in one implementation the processing circuitry may comprise a plurality of pipeline stages, and the history storage may comprise a speculative history and a committed history. The speculative history may be updated in dependence on branch outcome predictions made by the prediction circuitry for branch instructions detected at a given pipeline stage, and the committed history may be updated in dependence on actual outcomes of the branch instructions when those branch instructions are subsequently executed at a later pipeline stage. In such an implementation, a state indication may be added in association with branch instructions passing through the pipeline stages to identify those branch instructions that resulted in a corresponding history indicator being generated using the modified indicator generation operation to update the speculative history. This state indication can hence flag where modified history indicators have been used, and thus assist in recreating the speculative history following a branch misprediction and subsequent flush of the processing pipeline (by enabling the speculative history to be recreated from the committed history and the state indications associated with the pending branch instructions in the pipeline ahead of the branch instruction that caused the flush to take place).

Whilst a single state indication bit may be sufficient in implementations where the algorithm used to generate modified history indicators is fixed, in implementations where the algorithm used to generate modified history indicators is not fixed, and may instead be altered dependent on one or more defined factors, then additional state indication bits may be added in association with the branch instructions passing through the pipeline stages to identify not only when a modified history indicator has been generated in association with a given branch instruction, but also to enable identification of the algorithm used to generate the modified history indicator.

In an alternative implementation, where a checkpointing scheme is used to maintain snapshots of the speculative history at various points in time, it may not be necessary to incorporate such state indications, since instead of seeking to recreate the speculative history following a flush, execution is rewound to a point in time for which a copy of the speculative history has been checkpointed, and the copy of the checkpointed speculative history is used when execution is resumed.

Particular examples will now be described with reference to the figures.

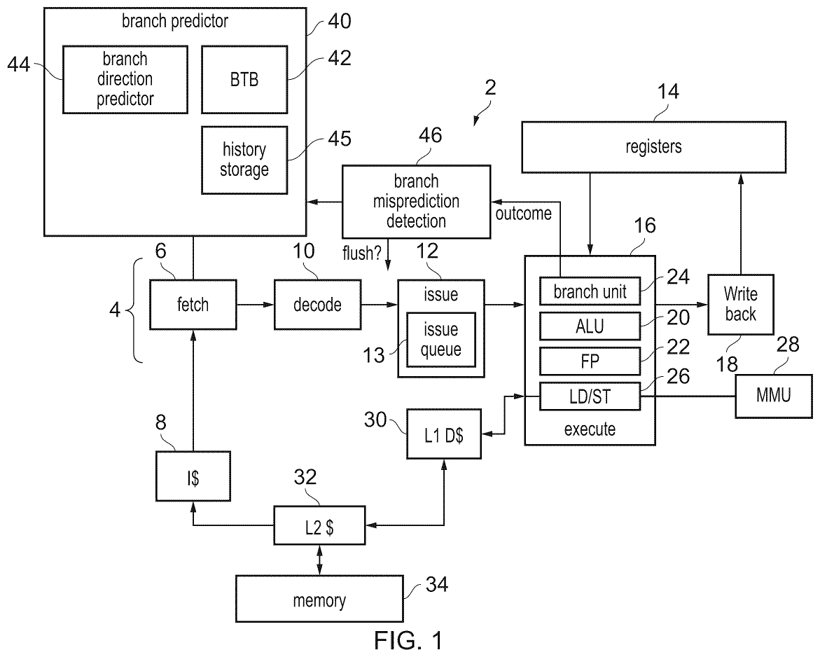

FIG. 1 schematically illustrates an example of a data processing apparatus 2 in accordance with one example implementation. The data processing apparatus has a processing pipeline 4 which includes a number of pipeline stages. In this example, the pipeline stages include a fetch stage 6 for fetching instructions from an instruction cache 8; a decode stage 10 for decoding the fetched program instructions to generate micro-operations to be processed by remaining stages of the pipeline; an issue stage 12 for queueing micro-operations in an issue queue 13 and checking whether operands required for the micro-operations are available in a register file 14 and issuing micro-operations for execution once the required operands for a given micro-operation are determined to be available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of a possible pipeline architecture, and other systems may have additional stages or a different configuration of stages. For example, in an out-of-order processor a register renaming stage could be included, e.g. between the decode stage 10 and issue stage 12, for mapping architectural registers specified by program instructions or micro-operations to physical register specifiers identifying physical registers in the register file 14. Also, for an out-of-order processor, the writeback stage 18 may use a reorder buffer to track completion of instructions executed out-of-order.

The execute stage 16 includes a number of processing units, for executing different classes of processing operation. For example the execution units may include a scalar arithmetic/logic unit (ALU) 20 for performing arithmetic or logical operations on scalar operands read from the registers 14; a floating point unit 22 for performing operations on floating-point values; a branch unit 24 for evaluating the outcome of branch operations and adjusting the program counter which represents the current point of execution accordingly; and a load/store unit 26 for performing load/store operations to access data in a memory system 8, 30, 32, 34. A memory management unit (MMU) 28 may be provided to perform memory management operations such as address translation and checking of memory access permissions. The address translation mappings and access permissions may be defined in page table structures stored in the memory system. Information from the page table structures can be cached in a translation lookaside buffer (TLB) provided in the MMU 28.

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 26 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness. The fetch stage 6 and decode stage 10 may be considered as an example of front end circuitry for supplying micro-operations for processing by the execute stage 16. The execute stage 16 (or alternatively, the pipeline 4 as a whole) can be regarded as an example of processing circuitry for performing processing operations.

As shown in FIG. 1, the apparatus 2 includes a branch predictor 40 for predicting outcomes of branch instructions. The branch predictor is looked up based on addresses of instructions to be fetched by the fetch stage 6 and provides a prediction of whether those instructions are predicted to include branch instructions, e.g. instructions capable of causing a non-sequential change in program flow (a change of program flow other than a sequential transition from one instruction address to the immediately following instruction address in a memory address space). For any predicted branch instructions, the branch predictor 40 provides a prediction of their branch properties such as a branch type, branch target address and branch direction (the branch direction indicating whether the branch is predicted to be taken or not taken). The branch predictor 40 includes a branch target buffer (BTB) 42 for predicting properties of the branches other than branch direction, a branch direction predictor (BDP) 44 for predicting the not taken/taken outcome (branch direction), and history storage circuitry 45 which stores history information indicative of the program flow history.

It will be appreciated that the branch predictor could also include other prediction structures not shown in FIG. 1, such as a history-dependent target address predictor for predicting branch target addresses for harder-to-predict branches (often referred to as polymorphic branches) whose target address depends on program flow history of instructions prior to the branch, a call-return stack for predicting return addresses of function calls, a loop direction predictor for predicting when a loop controlling instruction will terminate a loop, or other more specialised types of branch prediction structures for predicting behaviour of outcomes in specific scenarios.

Branch misprediction detection circuitry 46 detects, based on outcomes of branch instructions executed by the branch unit 24 of the processing circuitry 4, 16, whether a branch has been incorrectly predicted, and controls the pipeline 4 to suppress effects of the incorrectly predicted branch instruction and cause execution of instructions to resume based on the correct branch outcome (e.g. by flushing operations that are younger than the branch in program order and resuming fetching from the instruction that should be executed after the branch). The prediction state data in the BTB 42 and branch direction predictor 44 is trained based on the outcomes of executed branch instructions detected by branch misprediction detection circuitry 46. While FIG. 1 shows the branch misprediction detection circuitry 46 as separate from the branch unit 24, execute stage 16 and branch predictor 40, in other examples the branch misprediction detection circuitry 46 could be regarded as part of the processing circuitry 4, 16 or part of the branch prediction circuitry 40.

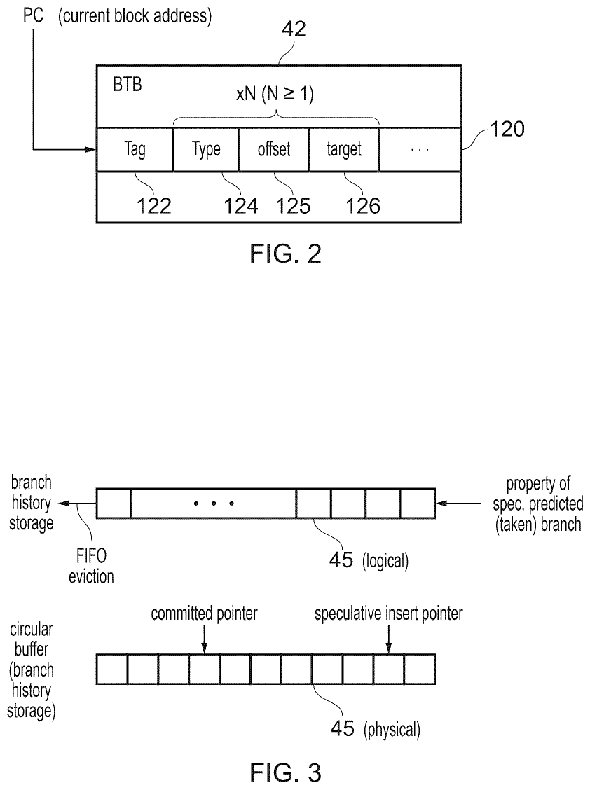

FIG. 2 illustrates an example of the BTB 42, which is a specific example of a history-independent branch target address predictor. The BTB 42 is implemented as a cache-like structure comprising a number of prediction entries 120 able to be allocated for respective addresses. The entries 120 are looked up based on a program counter (PC) address representing the current point in program flow for which a branch prediction is to be generated, in one example implementation this being the address of a current block of one or more instructions for which the prediction lookup is to be made. In many modern processors, the BTB 42 is looked up for a block of instructions at a time, so the program counter may represent the first instruction in the looked up block. For example, the program counter may be the address of a block of instructions determined to be fetched by the fetch stage 6 and the branch predictor may be looked up to identify whether that block of instructions will contain any branches, so that the address of the next block of fetched instructions can be predicted.

Each prediction entry 120 specifies an address tag value 122 used on lookups to the BTB 42 to determine whether that prediction entry 120 relates to the PC address supplied for the BTB lookup. For example, a tag value generated based on a portion of the PC address or as a hash of the PC address may be compared with the tag 122 of a given subset of prediction entries (e.g. the given subset of prediction entries may comprise all of the prediction entries 120, or a limited subset of prediction entries in a set-associative approach). If one of those entries has a tag 122 matching the tag value generated from the input PC address, then a hit is detected in the BTB and a branch prediction can be generated based on contents of the prediction entry 120 (referred to as the “hit prediction entry”) that had the matching tag value 122. If none of the looked up subset of prediction entries 120 has a matching tag value 122 corresponding to the input PC address then a miss is detected and the instruction at the target address is predicted to not require any taken branch, and so instruction fetching may resume sequentially beyond that PC address.

If a hit is detected in the BTB 42, then the hit prediction entry provides a number of other items of prediction state. In the example shown in FIG. 2, these include a predicted branch type 124 (which could for example indicate whether the branch is a conditional branch, a non-conditional branch, a polymorphic branch, or other branch types), a branch offset 125 which indicates an offset of the instruction address of the branch relative to the instruction address of the first instruction in the current block, and a branch target address 126 predicted to be the address of the instruction to which the branch would redirect program execution if the branch was taken. As shown in FIG. 2, it is possible for the BTB entry to include more than one set of branch properties, to predict properties of two or more branches in the same block.

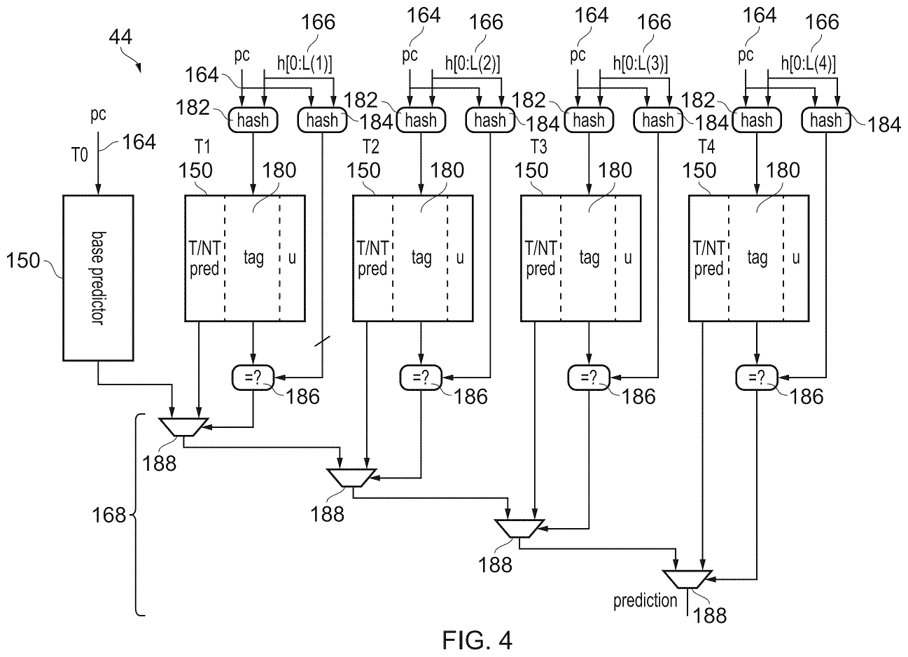

FIG. 3 illustrates an example of the history storage 45. The upper part of FIG. 3 shows a logical view of the history information contained by the history storage. Logically, the history information may be maintained as a FIFO (first-in, first out) buffer, where a certain number of elements of program flow history are maintained, and when an update is made to the history information, a property of a speculatively predicted taken branch is shifted in as a new element at one end of the buffer, causing all the existing elements to shift up one position and the oldest elements to be discarded. For example, the property shifted in to the history buffer could be a value derived from at least one of the program counter address and branch target address for the taken branch. For example, a hash function may be applied to the program counter address and/or branch target address for the taken branch, to derive the value shifted into the history information. Hence, the branch history information stored in history storage 45 may provide a sequential record of the most recent N taken branches in the program flow encountered before the current point of program flow whose address is being input to the branch predictor 40 to generate a latest branch prediction. Other examples could also shift properties of non-taken branches into the history storage. In this case, the property could be an indication of whether the branch is taken or not-taken. Note that the history information maintained by history storage 45 depends on the order in which the corresponding branches are encountered. The same branches occurring in a different order may cause different values of the history information to be maintained by history storage circuitry 45.

As shown in the lower part of FIG. 3, while some examples could implement the physical storage for the history storage circuitry 45 as an actual shift register in which an insertion of a new element into the history storage 45 causes physical shifting elements of the history information up one position, other examples can implement the physical storage for the history storage circuitry 45 as a circular buffer in which the elements stored in the history buffer 45 remain at static positions even when new elements are inserted, but a “speculative insert pointer” is used to track the point of the buffer at which the next element should be inserted when a branch prediction is made. When a new element is inserted into the buffer, it is inserted at a position determined based on the speculative insert pointer, and the speculative insert pointer is updated to advance to the next location of the buffer (wrapping around to the beginning of the buffer if the previous entry identified by the speculative insert pointer was at the end of the buffer). Similarly, a “committed pointer” may track the point of the buffer corresponding to the point of program flow for which all previous processing is known to be correct following resolution of earlier branch outcomes. When the branch unit 24 resolves a branch outcome for a given instruction for which a previous branch prediction was made, if the prediction was correct then the previous speculative update to the history information can be committed, by advancing the committed pointer to point to the next entry (again, wrapping around to the beginning of the buffer when necessary). If the prediction was incorrect then one or more previous speculative updates to the history information can be reversed, e.g. by rewinding the speculative insert pointer to be equal to the committed pointer, or if backup “restoration values” of the speculative insert pointer at given points of program flow were captured, by setting the speculative insert pointer to the one of those restoration values which corresponds to a point of program flow before the point of program flow at which the misprediction occurred.

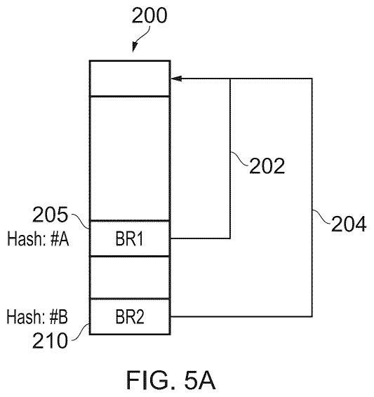

FIG. 4 shows a specific example of a branch direction predictor (BDP) 44, which is a TAGE (tagged-geometric) predictor comprising branch prediction tables 150 including a base prediction table TO and a number of tagged-geometric (TAGE) tables T1 to T4. While this example shows four TAGE tables for conciseness, it will be appreciated that TAGE predictors could be provided with a larger number of tables if desired, e.g. 8 or 16. The base predictor T0 is looked up based on the program counter PC alone, while the TAGE tables T1 to T4 are looked up based the PC 164 and successively increasing lengths of history information 166, so that T1 uses a shorter sequence of history information compared to T2, T2 uses a shorter sequence of history information compared to T3, and so on. For example, table T1 may use the most recent entries 0 to L(1) from the history storage 45, table T2 may use the most recent entries 0 to L(2) from the history storage (where L(2) is an entry allocated to history storage 45 less recently than entry L(1)), and so on. In this example T4 is the table which uses the longest sequence of history information. Each prediction entry specifies a prediction counter (“pred”), for example a 2-bit counter which provides a bimodal indication of whether the prediction is to be taken or not taken (e.g. counter values 11, 10, 00, 01 may respectively indicate predictions of: strongly predicted taken, weakly predicted taken, weakly predicted not taken, and strongly predicted not taken). Each entry also specifies a tag value 180 which is compared with a tag hash generated from the program counter 164 and history information 166 to detect whether the entry corresponds to the current block being looked up (the tag distinguishes between multiple blocks whose index hash values alias onto the same entry of the table). The lookup circuitry includes index hashing circuitry 182 for generating an index hash used to select one or more selected entries of the table, tag hashing circuitry 184 for generating a tag hash value to be written to a newly allocated entry or for comparing with an existing entry's tag value 180 on a lookup, and comparison circuitry 186 for comparing the tag value 180 read out from one or more looked up entries with the calculated tag hash generated by the tag hashing circuitry 184 to determine whether a hit has been detected. Each prediction entry of the branch direction predictor 44 may also have a usefulness value (u) used for controlling replacement of prediction entries (e.g. the usefulness value of a given entry may be reset to an initial value when a hit is detected against that entry or when the entry is first allocated, and the usefulness values of all entries in a given table may be incremented in response to a miss in that table or on an allocation of a new entry, so that over time the usefulness values may distinguish more frequently used entries from less frequently used entries).

For a TAGE predictor, TAGE prediction generating circuitry 168 comprises a cascaded sequence of selection multiplexers 188 which select between the alternative predictions returned by any of the prediction tables 150 which generate a hit. The base predictor 150 may be used as a fall-back predictor in case none of the other TAGE tables generate a hit (a hit occurs when the tag in the looked up entry matches the tag hash generated based on the indexing information). The cascaded multiplexers are such that if the table T4 indexed with the longest sequence of history generates a hit then its prediction will be output as the prediction result, but if it misses then if the preceding table T3 generates a hit then the T3 prediction will be output as the overall prediction for the current block, and so on, so that the prediction which gets selected is the prediction output by the table (among those tables which generated a hit) which corresponds to the longest sequence of history considered in the indexing. That is, any tables which miss are excluded from the selection, and among the remaining tables the one with the longest sequence of history in its indexing information is selected, and if none of the TAGE tables T1 to T4 generate a hit then the base predictor T0 is selected.

This approach is extremely useful for providing high performance because a single table indexed with a fixed length of branch history has to trade off the accuracy of predictions against the likelihood of lookups hitting in the table. A table indexed with a relatively short sequence of branch history may be more likely to generate a hit, because it is more likely that the recently seen history leading to the current block is the same as a previously seen sequence of history for which an entry is recorded in the table, but as the shorter sequence of history cannot distinguish as precisely between the different routes by which the program flow may have reached the current block, it is more likely that the prediction indicated in the hit entry may be incorrect. On the other hand, for the table T4 which is indexed based on the longest sequence of history, this can be extremely useful for predicting harder to predict branches which need to delve further into the past in terms of exploring the history so that that the pattern of program execution which led to that branch can be characterised and an accurate prediction made, however, it is less likely on subsequent occasions that the longer sequence of history will exactly match the sequence of history leading up to the current block and so the hit rate is lower in a table indexed based on a longer sequence of history. By providing a range of tables with different lengths of history used for indexing, this can balance these factors so that while the hardest to predict branches which would be difficult to predict using other branch predictors can be successfully predicted with the longer table T4, other easier to predict branches which do not require the full prediction capability of T4 can be predicted using one of the earlier tables indexed based on shorter history so that it is more likely that a hit will be detected on a prediction lookup, thus increasing the percentage of branches for which a successful prediction can be made and therefore improving prediction accuracy and performance. Hence, TAGE predictors are one of the most accurate predictors known.

Whilst a TAGE predictor has been discussed above with reference to FIG. 4 as an example of a predictor that makes use of the history information in the history storage 45 when making predictions, it should be noted that the techniques described herein are not restricted to use in connection with such a predictor, and any other suitable form of predictor may also be used. Purely by way of illustration, a perceptron predictor may be used instead of a TAGE predictor to predict branch directions, and also would make use of the history information in the history storage 45 when making such predictions. In particular, the perception predictor will use the history information in order to identify a number of entries in a prediction storage structure, where each of those entries provides weight information. The weights obtained from each of the identified entries are then combined in order to form a final prediction.

As discussed earlier, the accuracy of the predictions made by a predictor that relies on using the history information in the history storage 45 will often depend on how accurately the history information can discriminate between different execution histories of the program being executed on the data processing apparatus. In accordance with the techniques described herein, update circuitry that is used to update the contents of the history storage is provided with a mechanism to detect whether an aliasing concern condition is present indicating that the history information may be insufficient, for at least one prediction event, to enable the prediction circuitry to discriminate between different contexts of that at least one prediction event that are dependent on execution history of the program. Further, the form of the history indicator generated in response to any given update event is dependent upon whether the aliasing concern condition is considered to be present or not. In particular, the update circuitry is configured, absent detection of the aliasing concern condition, to perform a default indicator generation operation to generate the history indicator associated with the given update event. However, when the aliasing concern condition is detected, the update circuitry is instead configured to perform a modified indicator generation operation to generate the history indicator associated with the given update event.

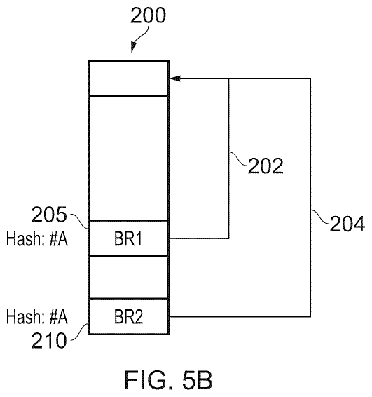

There are various ways in which the aliasing concern condition may be detected. FIGS. 5A and 5B are used to illustrate one scenario where the aliasing concern condition may arise. FIG. 5A illustrates a sequence of code 200 comprising an inner loop 202 and an outer loop 204. The inner and outer loops are terminated by associated branch instructions BR1 205 and BR2 210. If the branch is taken, then the corresponding loop repeats whereas if the branch is not taken, then the corresponding loop terminates. For the purposes of illustration, it will be considered that the inner loop 202 is taken three times, and the outer loop 204 is taken for a long time. Each time the branch instruction BR1 or the branch instruction BR2 is considered to be taken, then a history indicator is generated by update circuitry for adding to the history storage 45. The value of the history indicator is generated by performing a predetermined arithmetic operation using as inputs a number of items of state associated with the taken branch, and in the example shown in FIG. 5A it is assumed that the predetermined arithmetic operation comprises performing a hash operation on those inputs in order to generate the history indicator value. The items of state used as input to the hash operation may vary dependent on implementation, and may for example include one or more bits of the target address determined for the branch instruction, and/or one or more bits of the program counter value of the branch instruction, and/or an indication of the type of branch instruction, etc. In one particular example implementation, the hash operation uses just a subset of bits of the target address determined for the branch instruction.

In the example shown in FIG. 5A it is assumed that the history indicator value generated by the hash operation when the branch BR1 205 is taken is #A, and that the history indicator value generated by the hash operation when the branch BR2 210 is taken is #B. Given that the values are different, this can enable the history information to be used to discriminate between different contexts of the branch instructions, and in particular to distinguish between taken and not taken contexts. For example, considering the branch instruction BR1, it will be noted that the value #A is added each time that branch is taken, and the value #B is added each time that branch is not taken (as a result of the subsequent branch BR2 being taken). Hence, the prediction circuitry can make the predictions indicated below for the outcome of branch instruction BR1 based on the following patterns being observed in the history information:
#BAAABAAABAAA (predict NT)
#BAAABAAABAA (predict T)
#BAAABAAABA (predict T)
#BAAABAAAB (predict T)

However, FIG. 5B illustrates an issue that could arise dependent on the history indicator values generated for the branch instructions BR1 205 and BR2 210. In particular, if the input state values used, in combination with the hash operation performed, means that the same history indicator value #A is generated when either branch instruction is taken, then it will be appreciated that the history storage will fill up with history indicators all having the value #A, and the branch direction predictor will then no longer be able to accurately discriminate between the taken and not taken contexts of the branch instruction BR1. As a result, it may for example be the case that all occurrences of the branch instruction BR1 are predicted as taken, but those predictions will be incorrect 25% of the time when considering the above specific example.

In another example implementation, it will be appreciated that the same situation could arise (i.e. where the history storage fills up with history indicators that all have the same value) in the context of a very long loop, where the same branch is repeatedly taken and hence the history storage just fills up with history indicators having the same value due to the large number of iterations of that loop. The chances of this happening may increase in low cost implementations where the history storage size is generally likely to be smaller, and hence is able to store less history.

Irrespective of the cause that results in aliasing or stagnation in respect of the contents of the history storage, the techniques described herein aim to enable the update circuitry that is used to generate the history indicators added to the history storage to detect when an aliasing concern condition has arisen, and in that event to alter at least one history indicator value inserted into the history storage to seek to introduce a perturbation, and hence add entropy to the contents of the history storage, thus increasing the likelihood that the contents of the history storage can be used to discriminate between different contexts of a branch instruction (or in the more general case between different contexts of a prediction event for which the prediction circuitry is generating a prediction).

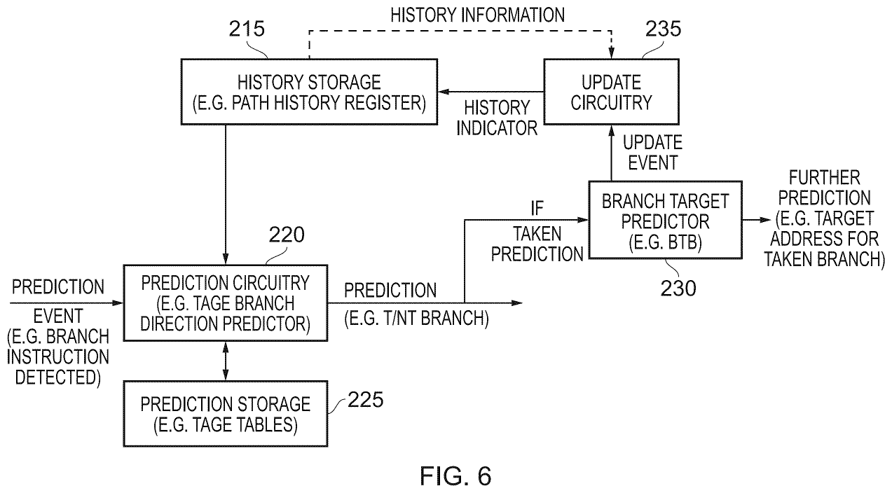

FIG. 6 is a block diagram schematically illustrating how update circuitry 235 may be used in accordance with the techniques described herein to update the history storage 215 in dependence on whether the earlier-mentioned aliasing concern condition is detected or not. As shown in FIG. 6, when a prediction event is detected by prediction circuitry 220, the prediction circuitry obtains from the history storage 215 the history information (or at least a portion of that history information) stored therein. In one example implementation, the prediction circuitry 220 may take the form of a branch direction predictor such as the branch direction predictor 44 shown in FIG. 1, and hence will have access to prediction storage 225, for example a series of TAGE tables that are indexed into using portions of the path history obtained from the history storage 215 (in such an implementation the history storage 215 may take the form of a path history register with the history indicators being generated based on taken branches observed during execution of a program on the data processing apparatus).

Hence, the prediction circuitry 220 will use the history information to perform a lookup in the prediction storage 225, and based on the accessed entry or entries within the prediction storage will then generate a prediction, in the example illustrated in FIG. 6 this being a taken or not taken prediction for the observed branch instruction. If the branch is predicted as taken, then the branch target predictor 230 (which may for example take the form of the BTB 42 of FIG. 1) can be used to predict a target address for that taken branch, as discussed earlier with reference to FIG. 2. In addition to that target address prediction being output by the branch target predictor, the generation of that target address can also be used to signal an update event to the update circuitry 235. In one example implementation the update circuitry will use a number of bits of the target address, potentially in combination with other state information such as the program counter of the branch instruction, to generate a history indicator to be added to the history storage 215 (which may for example be updated in the manner discussed earlier with reference to FIG. 3). However, in accordance with the techniques that will be described in more detail herein, the update circuitry is arranged, prior to updating the history storage, to determine whether use of the history indicator generated in the above manner would give rise to the aliasing concern condition being detected in respect of the history storage. There are a number of ways in which this determination may be made, as will be discussed in more detail later, and in one example implementation this may involve reference to the existing history information of the history storage prior to the update, as indicated by the dotted line in FIG. 6.

In the event that the aliasing concern condition is detected, then rather than using the default history indicator generated based on the input state information for the update event, the update circuitry will perform a modified indicator generation operation in order to generate a modified history indicator to be used instead to update the history storage. In one example implementation, this is achieved by performing a reproducible modification operation on the default history indicator, either to replace that default history indicator with a replacement history indicator used as the modified history indicator, or to cause one or additional bits to be added to the default history indicator in order to generate the modified history indicator.

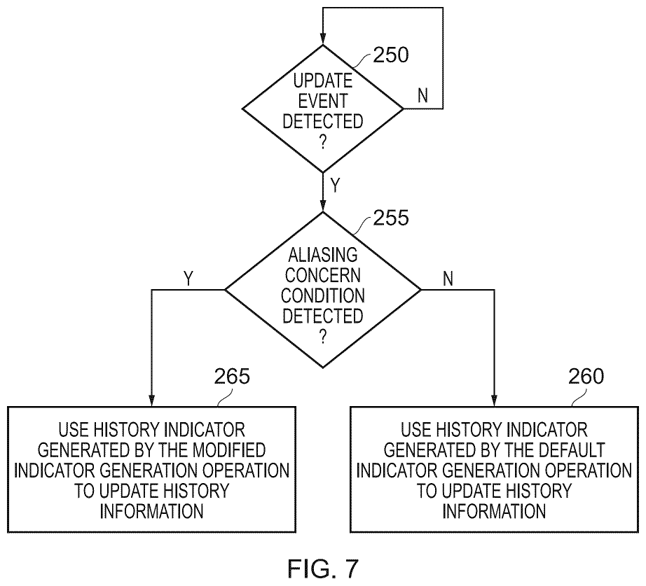

FIG. 7 is a flow diagram schematically illustrating the processing performed by the update circuitry 235 of FIG. 6. When at step 215 an update event is detected, it is determined at step 255 whether the aliasing concern condition is detected. If not, then at step 260 a default history indicator as generated by a default indicator generation operation performed by the update circuitry is used to update the history information within the history storage 215. However, it instead the aliasing concern condition is detected at step 255, then at step 265 a modified indicator generation operation is performed in order to generate a modified history indicator that is then used to update the history information.

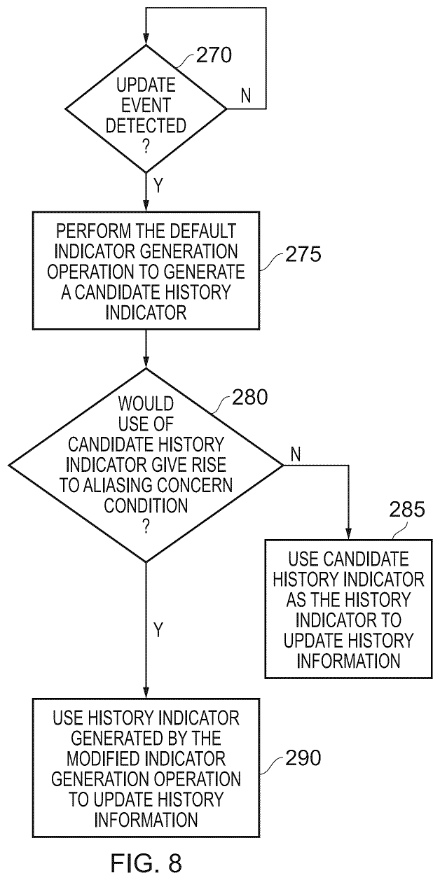

There are various ways in which the aliasing concern condition may be detected, but in one example implementation a check for the presence of the aliasing concern condition is made after the default indicator generation operation has been performed in order to generate a proposed history indicator (the default history indicator) to be used to update the history information in the history storage. This approach is illustrated schematically by the flow diagram of FIG. 8. As shown, if at step 270 an update event is detected, then at step 275 the default indicator generation operation is performed in order to generate a candidate history indicator. Then, at step 280 it is determined whether use of the candidate history indicator would give rise to the aliasing concern condition. If not, then at step 285 the candidate history indicator is employed as the history indicator to be used to update the history information in the history storage. However, if use of the candidate history indicator would give rise to the aliasing concern condition, then at step 290 a modified history indicator is generated by the modified indicator generation operation and is then used to update the history information in the history storage. In one example implementation, the modified history indicator is generated either by performing a predetermined arithmetic operation on the default history indicator in order to generate a replacement history indicator, or by generating in a repeatable manner one or more additional indicator bits that are used, in combination with the default history indicator, as the modified history indicator.

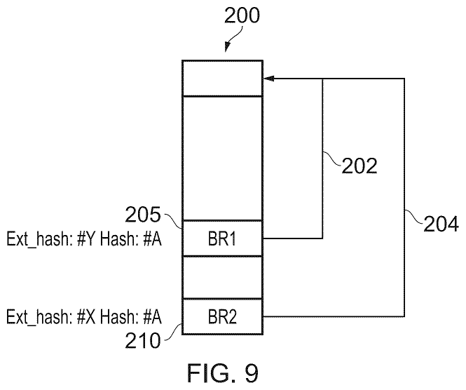

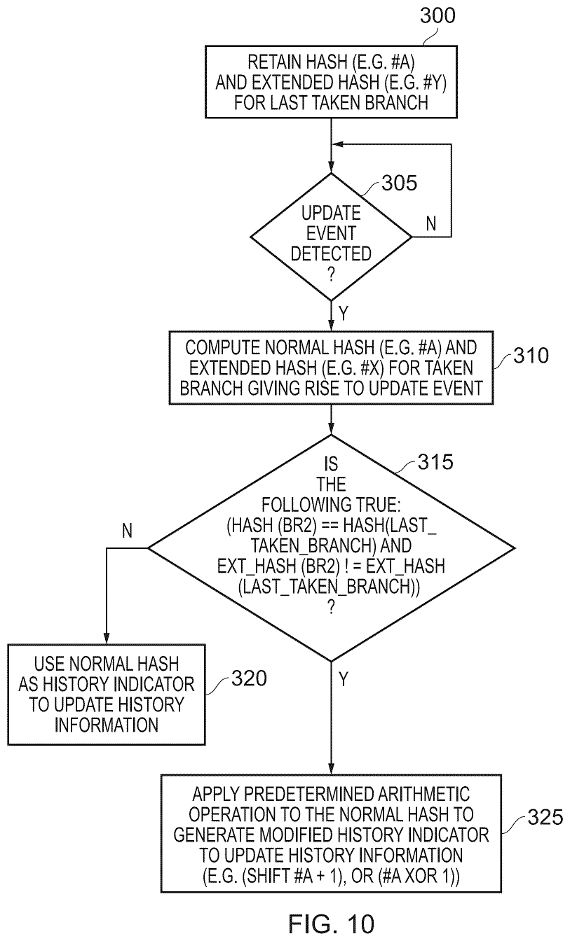

FIG. 9 and FIG. 10 illustrate one mechanism that may be used for detecting the aliasing concern condition, and for generating a modified history indicator in the presence of the aliasing concern condition. FIG. 9 shows the same code sequence 200 as discussed earlier with reference to FIGS. 5A and 5B and again shows a scenario where the hash operation performed generates the same history indicator value (I.e. #A) for both the branch instructions BR1 205 and BR2 210. Hence, in this scenario there is an input aliasing issue, since the state information used for both branch instructions results in a history indicator value being generated that does not discriminate between an occurrence of branch BR1 being taken and an occurrence of branch BR2 being taken (following branch BR1 not being taken). However, as shown in FIG. 9, the update circuitry also generates extended history indicator values (also referred to herein as extended hash values since in the illustrated example a hash operation is used to generate history indicators) when generating the default history indicator values (also referred to herein as default hash values). The extended history indicator values comprise more bits than the default history indicator values, and hence are more likely to result in different values for different branches, and hence enable a discrimination between the two branches to be made (in the particular example shown in FIG. 9 it is assumed that an extended hash value #Y is generated for branch BR1, but a different extended hash value #X is generated for branch BR2). Whilst in one example implementation the same input state information may be used by both the default hash operation and the extended hash operation, in another example implementation the extended hash operation may receive additional state indication information, which can further assist in detecting aliasing of the default history indicators for two different branches by increasing the likelihood that the extended history indicators will differ even if the default history indicators do not.

This process as discussed in more detail with reference to FIG. 10. In particular, at step 300, both the default hash value and the extended hash value for the last taken branch are retained. Hence, if we consider a scenario where branch instruction BR1 has just been taken for the final time in a particular iteration of the inner loop, the hash value and extended hash value retained by the update circuitry will be #A and #Y, respectively. At step 305, it is determined whether an update event has been detected, which in one example implementation will occur when a next taken branch is detected, and when an update event is detected the process proceeds to step 310 where the normal, default, hash value and the extended hash value are generated for the taken branch given rise to the update event. If, by way of example, the update event in question relates to branch BR2 being taken, then this will result in a default hash value and an extended hash value of #A and #X, respectively, when considering the earlier example of FIG. 9.

At step 315 the computation illustrated therein is performed. In particular, the update circuitry detects whether the default hash generated at step 310 matches the default hash retained at step 300, and in that event whether the extended hash generated at step 310 differs from the extended hash generated at step 300. If both the default hashes and the extended hashes match, then this indicates that both the current update event and the last update event related to different iterations of the same underlying branch (e.g. two iterations of BR1 being taken), and hence it would be entirely appropriate for the same history indicator values to be added to the history storage. However, if the default hashes match but the extended hashes do not, then this signifies that there may be aliasing between two different branch events (e.g. an occurrence of branch BR1 being taken, followed by an occurrence of branch BR2 being taken), and hence this can be used in the example implementation of FIG. 10 to indicate the presence of the aliasing concern condition.

If the aliasing concern condition is not detected, i.e. the condition indicated in step 315 is not present, then the process proceeds to step 320 where the normal, default, hash value is employed as the history indicator to be used to update the history information. However, if the aliasing concern condition is detected, i.e. the condition indicated at step 315 is true, then the process proceeds to step 325, where a predetermined arithmetic operation is applied to the normal hash value in order to generate a modified history indicator (also referred to herein as a modified hash value), and that modified history indicator is then used to update the history information in the history register. The predetermined arithmetic operation can take a variety of forms, but in the two specific examples illustrated in FIG. 10, if the normal hash value is #A, the modified hash value may be generated by performing either the computation “Shift #A+1” or “#A XOR 1”. Such arithmetic operations result in the generation of a modified hash value that has the same number of bits as the normal, default hash value, and can readily be inserted into the history information within the history storage in place of the normal hash value. Due to the generation of the modified hash value, a perturbation will be made to the contents of the history information that would not have occurred if the normal hash value had been used, and this perturbation increases the entropy within the contents of the history register, and hence increases the likelihood that the history information stored in the history register can be used to distinguish between different contexts of branch instructions when that history information is used by prediction circuitry.

Whilst in the example of FIG. 10, it is the default hash value and the extended hash value for the last taken branch that are retained for comparison purposes, if desired the default hash value and extended hash value for multiple previous taken branches could be retained, and the process of FIG. 10 repeated for each of those retained pairs of values. This would enable the update circuitry to detect whether any one of the previous taken branches for which the hash value and extended hash value have been retained used the same hash value as generated for a current update event, but related to a different underlying branch than the branch giving rise to the current update event, and in that case to trigger detection of the aliasing concern condition. Such an approach could for example be used to not just de-alias sequential, but different, branch instructions for which the same hash value is generated, but any different branch instructions appearing within a certain window of execution for which the same hash value is generated. However, in practice, it has been found that most of the benefit can be realised by just considering the immediately preceding branch instruction.

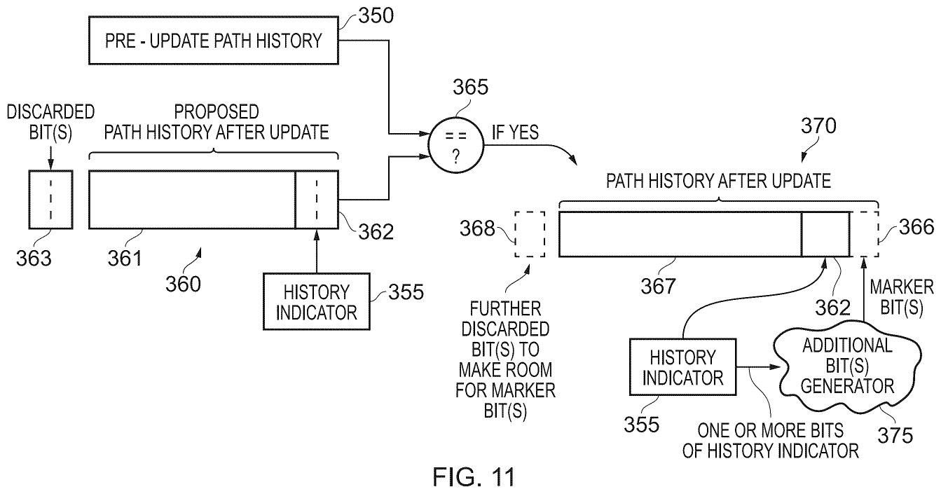

FIG. 11 illustrates an alternative approach that may be used to detect the aliasing concern condition, and to generate a modified history indicator in the presence of the aliasing concern condition. In this example, the technique used seeks to detect stagnation in the contents of the history information, referred to as the path history in FIG. 11. In particular, a copy of the existing path history 350 prior to an update being made is obtained by the update circuitry. In addition, on occurrence of an update event, a default history indicator 355 is generated and an updated path history 360 is generated by performing an effective left shift operation to insert the new history indicator bits 362 into the path history, and to discard a corresponding number of oldest history indicator bits 363. Hence, the new proposed path history 360 comprises a portion 361 formed of pre-existing history information within the path history and a number of additional history indicator bits 362 generated using the default indicator generation operation.

As indicated by the comparison block 365, the proposed path history 360 is compared with the pre-update path history 350. If these differ, then the path history can be updated to be the proposed path history 360. However, if the proposed path history after the update 360 matches the pre-update path history 350, this indicates stagnation in the path history contents, and in particular indicates that the addition of the new history indicator has not inserted any useful information into the path history. In that event, then as shown in the right-hand side of FIG. 11, the default history indicator 355 is in this example implementation still used to add the new history indicator bits 362, but in addition one or more marker bits 366 are also added, resulting in a corresponding number of further discarded bits 368 being discarded from the path history. These marker bits are generated by an additional bit(s) generator operation 375, which in the example shown uses one or more bits of the generated default history indicator as an input.

It will be appreciated that by such an approach, a perturbation is again introduced into the path history, and the path history as actually updated 370 will comprise a portion 367 made up of part of the path history pre-update 350, one or more new history indicator bits 362 generated by the default indicator generation operation, and one or more further marker bits 366 added as a result of performing the modified indicator generation operation. As a result, this can increase the entropy in the contents of the path history, and aid in discriminating between different contexts of a particular prediction event, such as the taken/not taken behaviour of a branch instruction.

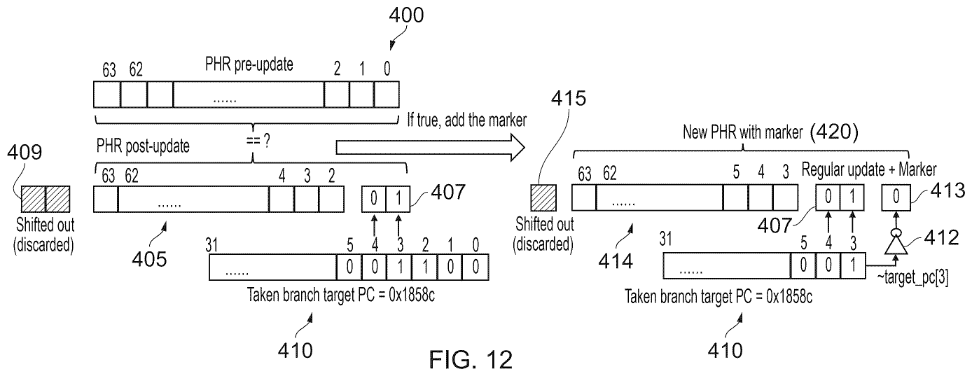

FIG. 12 illustrates a specific example of the approach illustrated schematically in FIG. 11. In this example, the default history indicator 407 is generated directly from predetermined bits of the target address 410 for the branch instruction in question, in a specific example bits 3 and 4 being used to form the default history indicator. Addition of the default history indicator would hence result in the two oldest bits of history information 409 being discarded. The update circuitry then determines whether the pre-update path history register contents 400 match the contents that would be present post-update, formed of the portions 405 and 407. If not, then the path history can be updated by insertion of the default history indicator 407 into the existing path history, and the discarding of the bits 409. However, if the pre-update PHR 400 matches the proposed post-update PHR, then as shown in the right-hand side of FIG. 12, an additional marker bit 413 can be generated, and gives rise to the new path history register contents post-update taking the form 420 (namely formed of portions 414, 407 and 413, with the existing history bit 415 being discarded). The marker bit 413 can be generated in a variety of ways, but in the example shown in FIG. 12 is merely generated by using inverter 412 to invert the least significant bit of the default history indicator, which in this case is bit 3 of the branch target address (for ease of illustration in FIG. 12, in the right-hand side of FIG. 12 bits 2, 1 and 0 of the target address are omitted). However, it will be appreciated that the marker bit or bits can be generated in any suitable manner, provided their generation is repeatable.

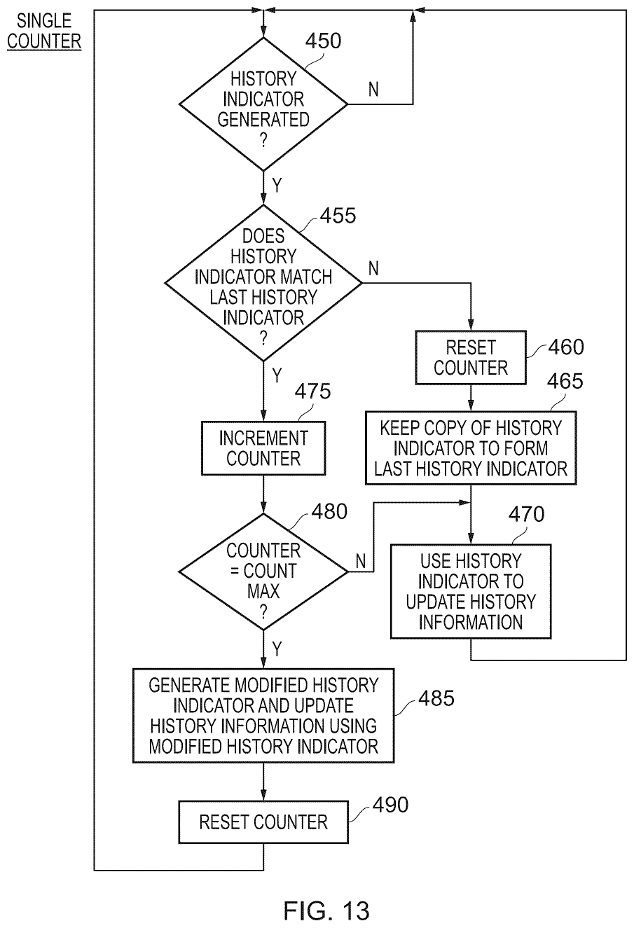

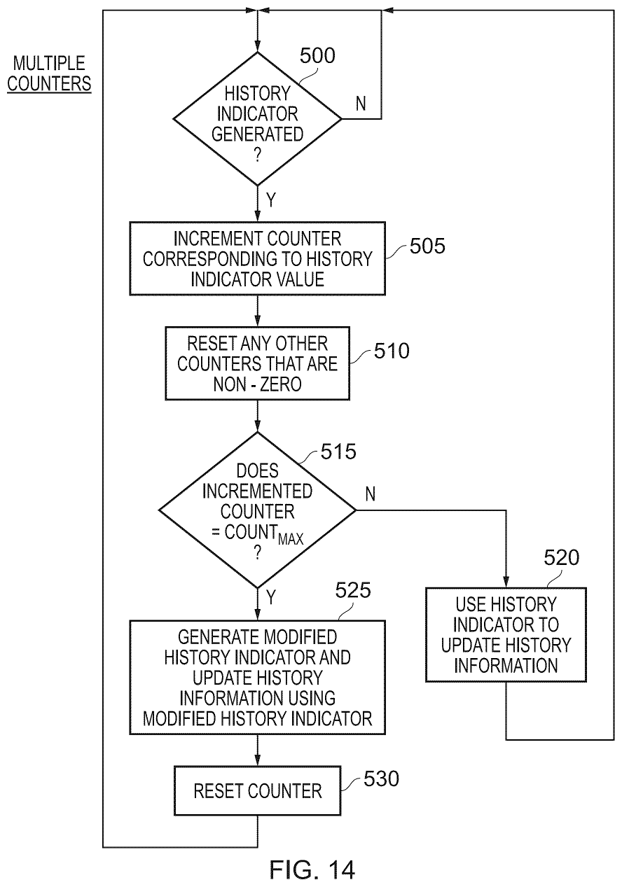

In the examples of FIGS. 11 and 12, a copy of the pre-update path history is required in order to perform a comparison of the contents pre-update with the proposed contents post-update. If desired, a portion of the path history rather than the entire path history could be used. Whilst retaining a portion or the entirety of the pre-update path history for comparison purposes may be appropriate in some implementations, for example where the path history register is relatively small, in other situations it may be considered undesirable to have to perform a comparison of pre-update contents to proposed post-update contents, for example in situations where the path history register is relatively large. FIGS. 13 and 14 illustrate two different counter based mechanisms that could be used to achieve the same functionality as that described with reference to FIGS. 11 and 12, but without the need for performing comparisons in respect of pre-update and post-update contents of the path history register.

In the example of the flow diagram of FIG. 13, a single counter is maintained for reference in determining whether the aliasing concern condition has arisen, and in particular whether the counter value indicates stagnancy in the contents of the path history. At step 450, it is determined whether a history indicator has been generated, as will be the case when the update circuitry receives an update event. In this example implementation, the update circuitry retains a copy of the last history indicator that was used to update the path history, and when it is detected at step 450 that a history indicator has been generated, it is then determined at step 455 whether the generated history indicator matches that last history indicator. If not, then the counter is reset at step 460 and a copy of the history indicator generated at step 450 is kept at step 465 to form the last history indicator for subsequent reference. At step 470, the history indicator generated at step 450 is then used to update the history information in the path history, and the process returns to step 450.

If at step 455, a match is detected, then at step 475 the counter is incremented, and at step 480 it is determined whether the value of the counter has reached a maximum counter value. If not, then the process proceeds to step 470 to cause the history indicator generated at step 450 to be used to update history information in the path history, and again the process returns to step 450.

If at step 480, the counter is determined to equal a maximum counter value, then this is used to indicate the presence of the aliasing concern condition, and in particular to indicate stagnancy in the contents of the path history, or at least a relevant part of the path history being considered. Accordingly, at step 485, a modified history indicator is generated using any of the techniques discussed earlier, and the history information in the path history is then updated using the modified history indicator. Thereafter, at step 490, the counter is reset, and the process returns to step 450.

It will be appreciated that the maximum counter value could be set in a variety of ways. However, merely by way of example, and considering a situation where stagnancy in the entire contents of the path history is seeking to be detected as the aliasing concern condition, if the length of the path history is M bits, and each history indicator is N bits, then if the counter reaches the value of M/N then this would indicate that the path history is full of history indicators having the same value, and hence would be indicative of the aliasing concern condition being detected.

In the example of FIG. 13, a comparison needs to take place at step 455 to determine whether the history indicator generated at step 450 matches the last history indicator. If it was desired to remove the need to retain a copy of the last history indicator, and to not perform that comparison, then instead the process of FIG. 14 could be used. In accordance with the approach of FIG. 14, a separate counter is maintained for each possible history indicator value. Hence, by way of example, if each history indicator comprises two bits, then four counters could be maintained.

At step 500, it is determined whether a history indicator is been generated, and if so then at step 505 the counter that corresponds to the generated history indicator value is incremented. In addition, at step 510 any other counters that are non-zero are reset. At step 515, it is determined whether the incremented counter equals the maximum counter value, and if not then at step 520 the history indicator generated at step 500 is used to update the history information in the path history. The process then returns to step 500.

However, if at step 515 it is determined that the counter does equal the maximum counter value, then the process proceeds to step 525 where a modified history indicator is generated using any of the techniques described earlier, and then the history information forming the path history is updated using that modified history indicator. The counter is then reset at step 530, and the process returns to step 500.

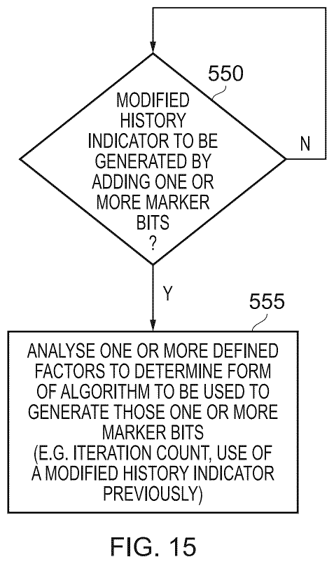

In implementations where the modified indicator generation operation is used to apply a reproducible modification to the default history indicator by generating in a repeatable manner one or more additional indicator bits that are used, in combination with the default history indicator, as the modified history indicator, then in one example implementation the algorithm used to generate the one or more additional bits may be fixed. However, in an alternative implementation, the update circuitry may be configured to alter the algorithm in a reproducible manner in dependence on one or more defined factors. This can provide further flexibility in the form of the modified history indicator that is added, and in particular may enable different mechanisms to be tried to seek to avoid future occurrences of the aliasing concern condition. For example, if a particular algorithm has been used to insert a modified history indicator, but in due course the aliasing concern condition has re-arisen, use of an alternative algorithm to generate a different form of modified history indicator may help in preventing further occurrences of the aliasing concern condition. Such an approach is illustrated schematically by the flow diagram of FIG. 15.

In particular, at step 550, it is determined whether a modified history indicator is to be generated by adding one or more marker bits to the default history indicator. If so, then at step 555 one or more defined factors are analysed in order to determine the form of algorithm to be used to generate those one or more marker bits. These factors could take a variety of forms, and hence for example could take into account an iteration count of a particular loop within the program, and/or whether a modified history indicator has already been inserted into the path history previously. If a modified history indicator has already been used, but stagnation has re-occurred, it may be considered appropriate to employ a different algorithm to generate an alternative form of modified history indicator with the aim of seeking to reduce the chance of the stagnation re-occurring again. By way of example, this could involve generating more marker bits on a subsequent occurrence of the stagnation than were used last time a modified history indicator was generated.

As will be apparent from the earlier discussion of FIG. 3, it may be the case that both a speculative path history and a committed path history are maintained within the data processing apparatus. Predictions can then be made using the speculative path history, and then as branch instructions are committed in the later stages of the processing pipeline, the committed path history can be updated based on the speculative path history. In the event of a misprediction, it is necessary to perform a flush operation. Whilst the committed path history will be unaffected by the flush, the speculative path history will need to be recreated before processing can continue. In some implementations, a checkpointing scheme is used to maintain copies of the speculative path history at certain points in time, and when rewinding operation following a flush, processing is rewound to a point at which a checkpointed speculative path history has been saved, hence allowing that checkpointed speculative path history to be used as a starting point. However, in alternative implementations it may be necessary to recreate the speculative path history from the committed path history. In order to enable such a process in the implementations described herein where modified history indicators may be used at certain points in time instead of default history indicators, then state information can be passed along the processing pipeline in association with branch instructions in order to identify any branch instructions that have resulted in a modified history indicator being generated.

If a single algorithm is defined for generating the modified history indicators, then merely a single state bit per branch instruction to identify whether a modified history indicator has been generated or not may be sufficient to enable the speculative path history to be recreated. However, in implementations where the algorithm used to generate modified history indicators is not fixed, and may instead be altered dependent on one or more defined factors, then additional state indications may be added in association with the branch instructions passing through the pipeline stages to identify not only when a modified history indicator has been generated in association with a given branch instruction, but also to enable identification of the algorithm used to generate the modified history indicator.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

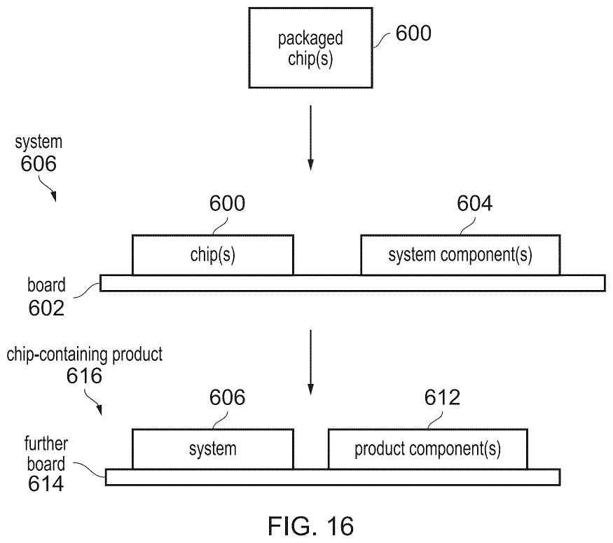

As shown in FIG. 16, one or more packaged chips 600, with the apparatus described above implemented on one chip or distributed over two or more of the chips, are manufactured by a semiconductor chip manufacturer. In some examples, the chip product 600 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 600 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. modular chips combined to provide the functionality of a single chip) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 600 are assembled on a board 602 together with at least one system component 604 to provide a system 606. For example, the board may comprise a printed circuit board. The board substrate may be made of any of a variety of materials, e.g. plastic, glass, ceramic, or a flexible substrate material such as paper, plastic or textile material. The at least one system component 604 comprise one or more external components which are not part of the one or more packaged chip(s) 600. For example, the at least one system component 604 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 616 is manufactured comprising the system 606 (including the board 602, the one or more chips 600 and the at least one system component 604) and one or more product components 612. The product components 612 comprise one or more further components which are not part of the system 606. As a non-exhaustive list of examples, the one or more product components 612 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 606 and one or more product components 612 may be assembled on to a further board 614.

The board 602 or the further board 614 may be provided on or within a device housing or other structural support (e.g. a frame or blade) to provide a product which can be handled by a user and/or is intended for operational use by a person or company.

The system 606 or the chip-containing product 616 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some example configurations are set out in the following numbered clauses:
1. An apparatus comprising:
   history storage configured to maintain history information comprising a sequence of history indicators generated during execution of a program by processing circuitry;
   update circuitry configured, responsive to a given update event detected during execution of the program, to generate a history indicator associated with the given update event, and to update the history information using the generated history indicator;
   prediction circuitry configured, responsive to a given prediction event detected during execution of the program, to use at least a portion of the history information to identify prediction information and to generate a prediction associated with the given prediction event in dependence on the identified prediction information;
   wherein:
   the update circuitry is configured to detect whether an aliasing concern condition is present indicating that the history information may be insufficient, for at least one prediction event, to enable the prediction circuitry to discriminate between different contexts of that at least one prediction event that are dependent on execution history of the program;
   the update circuitry is configured, absent detection of the aliasing concern condition, to perform a default indicator generation operation to generate the history indicator associated with the given update event; and
   the update circuitry is configured, when the aliasing concern condition is detected, to perform a modified indicator generation operation to generate the history indicator associated with the given update event.
2. An apparatus as in Clause 1, wherein the update circuitry is configured to perform the default indicator generation operation in order to generate a candidate history indicator, and in the event that updating the history information using the candidate history indicator would give rise to the aliasing concern condition, to instead update the history information using the history indicator generated by performing the modified indicator generation operation.
3. An apparatus as in Clause 1 or Clause 2, wherein:
   the update circuitry is configured to employ the default indicator generation operation to generate the history indicator based on at least one item of state associated with the given update event; and
   the update circuitry is configured, when the aliasing concern condition is detected, to perform the modified indicator generation operation in order to apply a reproducible modification to the history indicator generated by the default indicator generation operation in order to generate a modified history indicator to be used as the history indicator associated with the given update event.
4. An apparatus as in Clause 3, wherein the applying of the reproducible modification comprises one of:
   applying a predetermined arithmetic operation to the history indicator generated by the default indicator generation operation in order to generate as the modified history indicator a replacement history indicator used instead of the history indicator generated by the default indicator generation operation;
   generating in a repeatable manner one or more additional indicator bits that are used, in combination with the history indicator generated by the default indicator generation operation, as the modified history indicator.
5. An apparatus as in Clause 4, wherein the update circuitry is configured to derive the one or more additional indicator bits by performing a predetermined computation using as input one or more bits of the history indicator generated by the default indicator generation operation.
6. An apparatus as in any preceding clause, wherein:
   the update circuitry is configured to detect the aliasing concern condition when the history indicator generated by the default indicator generation operation for the given update event has a same value as the history indicator used to update the history information that was associated with a preceding update event, when that preceding update event is other than a previous iteration of the given update event.
7. An apparatus as in Clause 6, wherein the preceding update event considered by the update circuitry is a last update event prior to the given update event.
8. An apparatus as in Clause 6 or Clause 7, wherein:
   the update circuitry is configured to generate each history indicator used to update the history information such that that history indicator comprises P bits;
   the update circuitry is configured, when performing the default indicator generation operation, to also perform an extended indicator generation operation to generate an extended history indicator comprising R bits, where R is great than P;
   the update circuitry is configured to maintain the history indicator and the extended history indicator generated for the preceding update event, and to detect the aliasing condition when the history indicator generated by the default indicator generation operation for the given update event has a same value as the history indicator generated for the preceding update event, but the extended history indicator generated by the extended indicator generation operation for the given update event has a different value to that of the extended history indicator generated by the extended indicator generation operation for the preceding update event.
9. An apparatus as in any preceding clause, wherein the update circuitry is configured to detect the aliasing concern condition when a stagnancy threshold is detected in respect of the history information maintained in the history storage.
10. An apparatus as in Clause 9, wherein the update circuitry is configured to detect the stagnancy threshold when at least a portion of at least one version of the history information prior to update in response to the given update event matches a corresponding portion of updated history information that would arise were a current version of the history information updated using the history indicator generated for the given update event by the default indicator generation operation.
11. An apparatus as in Clause 9, wherein the update circuitry comprises counter circuitry used to track a number of consecutive updates to the history information that use a same value of the history indicator, and to detect the stagnancy threshold when that number reaches a threshold value.
12. An apparatus as in any preceding clause when dependent on Clause 4, wherein when the applying of the reproducible modification comprises generating in a repeatable manner one or more additional indicator bits that are used, in combination with the history indicator generated by the default indicator generation operation, as the modified history indicator, the update circuitry is configured to apply an algorithm to generate the one or more additional bits where that algorithm is altered in a reproducible manner in dependence on one or more defined factors.
13. An apparatus as in Clause 12, wherein the one or more defined factors comprise at least one of:
   an iteration count associated with a loop of instructions being executed within the program;
   a previous use of a modified history indicator to update the history information.
14. An apparatus as in any preceding clause, wherein:
   the history storage is configured to maintain, as the history information, path history information indicative of paths through the program that occur when the program is executed by the processing circuitry;
   the given update event is associated with a branch instruction in the program that causes a taken path to be followed from the branch instruction;
   the given prediction event comprises detection of an upcoming branch instruction in the program and the prediction circuitry is configured to generate a prediction of a branch outcome for the upcoming branch instruction; and
   the different contexts that the prediction circuitry may be unable to discriminate between based on the history information, when the aliasing condition is present, are different branch outcomes for at least one upcoming branch instruction.
15. An apparatus as in Clause 14, further comprising:
   prediction storage having a plurality of prediction entries, each prediction entry configured to store prediction information used to generate a prediction of the branch outcome;
   wherein the prediction circuitry is configured, responsive to the given prediction event, to use at least a portion of the history information to identify at least one prediction entry within the prediction storage, and to generate the prediction in dependence on the prediction information stored in the at least one identified prediction entry.
16. An apparatus as in Clause 14 or Clause 15, wherein:
   the processing circuitry comprises a plurality of pipeline stages;
   the history storage comprises a speculative history and a committed history, the speculative history being updated in dependence on branch outcome predictions made by the prediction circuitry for branch instructions detected at a given pipeline stage, and the committed history being updated in dependence on actual outcomes of the branch instructions when those branch instructions are subsequently executed at a later pipeline stage; and
   a state indication is added in association with branch instructions passing through the pipeline stages to identify those branch instructions that resulted in a corresponding history indicator being generated using the modified indicator generation operation to update the speculative history.
17. A method of managing a history storage used for prediction, comprising:
   maintaining within the history storage history information comprising a sequence of history indicators generated during execution of a program by processing circuitry;
   generating, in response to a given update event detected during execution of the program, a history indicator associated with the given update event, and updating the history information using the generated history indicator;
   employing prediction circuitry, in response to a given prediction event detected during execution of the program, to use at least a portion of the history information to identify prediction information, and to generate a prediction associated with the given prediction event in dependence on the identified prediction information;
   detecting whether an aliasing concern condition is present indicating that the history information may be insufficient, for at least one prediction event, to enable the prediction circuitry to discriminate between different contexts of that at least one prediction event that are dependent on execution history of the program;
   when generating the history indicator in response to the given update event, in the absence of the aliasing concern condition being detected, performing a default indicator generation operation to generate the history indicator; and
   when generating the history indicator in response to the given update event, in the presence of the aliasing concern condition being detected, performing a modified indicator generation operation to generate the history indicator.
18. A system comprising:
   the apparatus of any of clauses 1 to 16, implemented in at least one packaged chip;
   at least one system component; and
   a board,
wherein the at least one packaged chip and the at least one system component are assembled on the board.
19. A chip-containing product comprising the system of clause 18, wherein the system is assembled on a further board with at least one other product component.
20. A computer-readable medium storing computer-readable code for fabrication of the apparatus of any of clauses 1 to 16.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
history storage configured to maintain history information comprising a sequence of history indicators generated during execution of a program by processing circuitry;
update circuitry configured, responsive to a given update event detected during execution of the program, to generate a history indicator associated with the given update event, and to update the history information using the generated history indicator;
prediction circuitry configured, responsive to a given prediction event detected during execution of the program, to use at least a portion of the history information to identify prediction information and to generate a prediction associated with the given prediction event in dependence on the identified prediction information;
wherein:
the update circuitry is configured to detect whether an aliasing concern condition is present indicating that the history information may be insufficient, for at least one prediction event, to enable the prediction circuitry to discriminate between different contexts of that at least one prediction event that are dependent on execution history of the program;
the update circuitry is configured, absent detection of the aliasing concern condition, to perform a default indicator generation operation to generate the history indicator associated with the given update event; and
the update circuitry is configured, when the aliasing concern condition is detected, to perform a modified indicator generation operation to generate the history indicator associated with the given update event.

2. An apparatus as claimed in claim 1, wherein the update circuitry is configured to perform the default indicator generation operation in order to generate a candidate history indicator, and in the event that updating the history information using the candidate history indicator would give rise to the aliasing concern condition, to instead update the history information using the history indicator generated by performing the modified indicator generation operation.

3. An apparatus as claimed in claim 1, wherein:
the update circuitry is configured to employ the default indicator generation operation to generate the history indicator based on at least one item of state associated with the given update event; and
the update circuitry is configured, when the aliasing concern condition is detected, to perform the modified indicator generation operation in order to apply a reproducible modification to the history indicator generated by the default indicator generation operation in order to generate a modified history indicator to be used as the history indicator associated with the given update event.

4. An apparatus as claimed in claim 3, wherein the applying of the reproducible modification comprises one of:
applying a predetermined arithmetic operation to the history indicator generated by the default indicator generation operation in order to generate as the modified history indicator a replacement history indicator used instead of the history indicator generated by the default indicator generation operation;
generating in a repeatable manner one or more additional indicator bits that are used, in combination with the history indicator generated by the default indicator generation operation, as the modified history indicator.

5. An apparatus as claimed in claim 4, wherein the update circuitry is configured to derive the one or more additional indicator bits by performing a predetermined computation using as input one or more bits of the history indicator generated by the default indicator generation operation.

6. An apparatus as claimed in claim 1, wherein:
the update circuitry is configured to detect the aliasing concern condition when the history indicator generated by the default indicator generation operation for the given update event has a same value as the history indicator used to update the history information that was associated with a preceding update event, when that preceding update event is other than a previous iteration of the given update event.

7. An apparatus as claimed in claim 6, wherein the preceding update event considered by the update circuitry is a last update event prior to the given update event.

8. An apparatus as claimed in claim 6, wherein:
the update circuitry is configured to generate each history indicator used to update the history information such that that history indicator comprises P bits;
the update circuitry is configured, when performing the default indicator generation operation, to also perform an extended indicator generation operation to generate an extended history indicator comprising R bits, where R is great than P;
the update circuitry is configured to maintain the history indicator and the extended history indicator generated for the preceding update event, and to detect the aliasing condition when the history indicator generated by the default indicator generation operation for the given update event has a same value as the history indicator generated for the preceding update event, but the extended history indicator generated by the extended indicator generation operation for the given update event has a different value to that of the extended history indicator generated by the extended indicator generation operation for the preceding update event.

9. An apparatus as claimed in claim 1, wherein the update circuitry is configured to detect the aliasing concern condition when a stagnancy threshold is detected in respect of the history information maintained in the history storage.

10. An apparatus as claimed in claim 9, wherein the update circuitry is configured to detect the stagnancy threshold when at least a portion of at least one version of the history information prior to update in response to the given update event matches a corresponding portion of updated history information that would arise were a current version of the history information updated using the history indicator generated for the given update event by the default indicator generation operation.

11. An apparatus as claimed in claim 9, wherein the update circuitry comprises counter circuitry used to track a number of consecutive updates to the history information that use a same value of the history indicator, and to detect the stagnancy threshold when that number reaches a threshold value.

12. An apparatus as claimed in claim 4, wherein when the applying of the reproducible modification comprises generating in a repeatable manner one or more additional indicator bits that are used, in combination with the history indicator generated by the default indicator generation operation, as the modified history indicator, the update circuitry is configured to apply an algorithm to generate the one or more additional bits where that algorithm is altered in a reproducible manner in dependence on one or more defined factors.

13. An apparatus as claimed in claim 12, wherein the one or more defined factors comprise at least one of:
an iteration count associated with a loop of instructions being executed within the program;
a previous use of a modified history indicator to update the history information.

14. An apparatus as claimed in claim 1, wherein:
the history storage is configured to maintain, as the history information, path history information indicative of paths through the program that occur when the program is executed by the processing circuitry;
the given update event is associated with a branch instruction in the program that causes a taken path to be followed from the branch instruction;
the given prediction event comprises detection of an upcoming branch instruction in the program and the prediction circuitry is configured to generate a prediction of a branch outcome for the upcoming branch instruction; and
the different contexts that the prediction circuitry may be unable to discriminate between based on the history information, when the aliasing concern condition is present, are different branch outcomes for at least one upcoming branch instruction.

15. An apparatus as claimed in claim 14, further comprising:
prediction storage having a plurality of prediction entries, each prediction entry configured to store prediction information used to generate a prediction of the branch outcome;
wherein the prediction circuitry is configured, responsive to the given prediction event, to use at least a portion of the history information to identify at least one prediction entry within the prediction storage, and to generate the prediction in dependence on the prediction information stored in the at least one identified prediction entry.

16. An apparatus as claimed in claim 14, wherein:
the processing circuitry comprises a plurality of pipeline stages;
the history storage comprises a speculative history and a committed history, the speculative history being updated in dependence on branch outcome predictions made by the prediction circuitry for branch instructions detected at a given pipeline stage, and the committed history being updated in dependence on actual outcomes of the branch instructions when those branch instructions are subsequently executed at a later pipeline stage; and
a state indication is added in association with branch instructions passing through the pipeline stages to identify those branch instructions that resulted in a corresponding history indicator being generated using the modified indicator generation operation to update the speculative history.

17. A method of managing a history storage used for prediction, comprising:
maintaining within the history storage history information comprising a sequence of history indicators generated during execution of a program by processing circuitry;
generating, in response to a given update event detected during execution of the program, a history indicator associated with the given update event, and updating the history information using the generated history indicator;
employing prediction circuitry, in response to a given prediction event detected during execution of the program, to use at least a portion of the history information to identify prediction information, and to generate a prediction associated with the given prediction event in dependence on the identified prediction information;
detecting whether an aliasing concern condition is present indicating that the history information may be insufficient, for at least one prediction event, to enable the prediction circuitry to discriminate between different contexts of that at least one prediction event that are dependent on execution history of the program;
when generating the history indicator in response to the given update event, in the absence of the aliasing concern condition being detected, performing a default indicator generation operation to generate the history indicator; and
when generating the history indicator in response to the given update event, in the presence of the aliasing concern condition being detected, performing a modified indicator generation operation to generate the history indicator.

18. A system comprising:
the apparatus of claim 1, implemented in at least one packaged chip;
at least one system component; and
a board,
wherein the at least one packaged chip and the at least one system component are assembled on the board.

19. A chip-containing product comprising the system of claim 18, wherein the system is assembled on a further board with at least one other product component.

20. A computer-readable medium storing computer-readable code for fabrication of the apparatus of claim 1.
